(19) United States
(12) Patent Application Publication
(10) Pub. No.: US 2016/0359567 A1
(43) Pub. Date: Dec. 8, 2016

(54) MULTI-ENDPOINT OPTICAL RECEIVER

(71) Applicant: Alcatel-Lucent USA Inc., Murray Hill, NJ (US)

(72) Inventor: Joseph J. Kakande, Jersey City, NJ (US)

(21) Appl. No.: 14/728,919

(22) Filed: Jun. 2, 2015

(51) Int. Cl. H04B 10/64

(52) U.S. Cl. CPC H04B 10/64

(57) ABSTRACT

An optical receiver includes a plurality of optical/electrical (O/E) converters to couple to a corresponding plurality of optical fibers. The optical receiver also includes an analog switch to receive a plurality of analog electric signals generated by the plurality of O/E converters and selectively provide one of the plurality of analog electric signals for conversion to a digital electrical signal. Some embodiments of the optical receiver may be used to connect a level-2 (L-2) switch in a data center to a plurality of optical fibers such as optical fibers used to interconnect switches in the data center.

### CROSS REFERENCE TO RELATED APPLICATIONS

This application is related to U.S. patent application Ser. No. ______ (Attorney Docket No. 4100-817287-US), entitled “MULTIPLE ENDPOINT OPTICAL TRANSMITTER” and filed on even date herewith, the entirety of which is incorporated by reference herein.

### BACKGROUND

Field of the Disclosure

The present disclosure relates generally to optical networks and, more particularly, to transceivers in optical networks.

Description of the Related Art

The efficiency and flexibility of an optical network can be improved by dynamically switching physical (and logical) endpoints associated with ports in the optical network. For example, dynamic optical routing can adjust the bandwidth between the optical network nodes (e.g., electronic routers) on demand to meet application requirements. For another example, aggregation switches and distribution switches in a data center can be interconnected with redundant sets of high-bandwidth optical fibers. Each optical fiber that connects an aggregation switch to a distribution switch is paired with a redundant optical fiber that connects the distribution switch to another (redundant) aggregation switch. The redundant optical fiber may be used for communication between the aggregation switches and the distribution switches in the event that the primary optical fiber fails or is otherwise unavailable. However, the optical network may become unstable if an aggregation switch or distribution switch receives the same data stream on the primary optical fiber and the redundant optical fiber. Consequently, switches can receive a data stream from the primary optical fiber or the redundant optical fiber, but not both at the same time.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, an apparatus is provided for a multi-endpoint optical receiver. The apparatus includes a plurality of optical/electrical (O/E) converters to couple to a corresponding plurality of optical fibers. The apparatus also includes an analog switch to receive a plurality of analog electric signals generated by the plurality of O/E converters and selectively provide one of the plurality of analog electric signals for conversion to a digital electrical signal.

In some embodiments, a method is provided for implementation in a multi-endpoint optical receiver. The method includes generating, at a plurality of optical/electrical (O/E) converters, a plurality of analog electric signals in response to a plurality of optical signals received from a corresponding plurality of optical fibers. The method also includes selectively providing, from an analog switch, one of the plurality of analog electric signals for conversion to a digital electrical signal.

In some embodiments, an apparatus is provided for multi-endpoint optical reception in a data center. The apparatus includes a level-2 (L-2) switch for implementation in the data center. The L-2 switch is configured to be coupled to a plurality of optical fibers by one or more optical receivers. Each of the one or more optical receivers includes a plurality of optical/electrical (O/E) converters to couple to a corresponding plurality of optical fibers and an analog switch. The analog switch is to receive a plurality of analog electric signals generated by the plurality of O/E converters and selectively provide one of the plurality of analog electric signals for conversion to a digital electrical signal.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an optical network according to some embodiments.

FIG. 2 is a block diagram of an optical network according to some embodiments.

FIG. 3 is a block diagram of an optical network including an access point that is connected to two endpoints by corresponding optical fibers according to some embodiments.

FIG. 4 is a block diagram of an optical network including an access point that is connected to two endpoints by corresponding optical fibers according to some embodiments.

FIG. 5 is a block diagram of a data link layer and a physical layer of an optical network according to some embodiments.

FIG. 6 is a block diagram of an optical network including an access point that is connected to multiple endpoints by corresponding optical fibers according to some embodiments.

FIG. 7 is a block diagram of an optical network that supports analog multi-endpoint switching for a plurality of optical lanes according to some embodiments.

FIG. 8 is a block diagram of a switching circuit according to some embodiments.

### DETAILED DESCRIPTION

Endpoints (such as aggregation switches or distribution switches) in a conventional optical network implement separate reception logic for each optical/electric (O/E) converter (such as a photodetector) that converts an optical signal received on one of the optical fibers into a corresponding electrical signal. Duplication of the reception logic associated with the primary optical fiber and the redundant optical fiber increases the capital cost of the switch (or related transceiver) and the power consumed by the switch (or related transceiver). Most of the increase in the capital cost and the power consumption is produced by the reception logic connected to each photodetector. For example, physical media dependent entities (PMDs) and physical media attachments (PMAs) in the reception logic can consume as much as 90% of the power needed to operate the optical receiver, whereas the photodetector typically consume less than 5% of the power.

The capital cost and power consumption of optical receivers implemented in endpoints of optical networks can be reduced by implementing a multi-endpoint optical receiver that includes an analog switch to receive a plurality of analog electric signals generated by a corresponding plurality of photodetectors and selectively provide one of the plurality of analog electric signals for conversion to a digital electrical signal. In some embodiments, the analog switch selectively provides one of the analog electric signals in response to detecting loss of one or more analog electric signals associated with other photodetectors. For example, the analog switch may provide an analog electric signal from a photodetector connected to a redundant optical fiber in response to detecting loss of signal from a photodetector connected to a primary optical fiber. The analog switch may also selectively provide one of the analog electric signals based on priorities associated with the photodetectors. For example, if analog electric signals from more than one of the plurality of photodetectors are present at inputs to the analog switch, the analog switch may provide the analog electric signal from the photodetector having the highest priority. Priorities of the photodetectors may be indicated by signals provided to a controller coupled to the analog switch. Some embodiments of the analog switch may also selectively provide one of the analog electric signals in response to control signals used to configure the optical network. Some embodiments of the multi-endpoint optical receiver include a plurality of analog switches to selectively provide one of a plurality of analog electric signals for each of a plurality of multiplexed lanes associated with the plurality of photodetectors. The lanes may be defined using wavelength division multiplexing, space division multiplexing (using multiple optical spatial modes, fiber cores, or fibers), polarization division multiplexing, and the like.

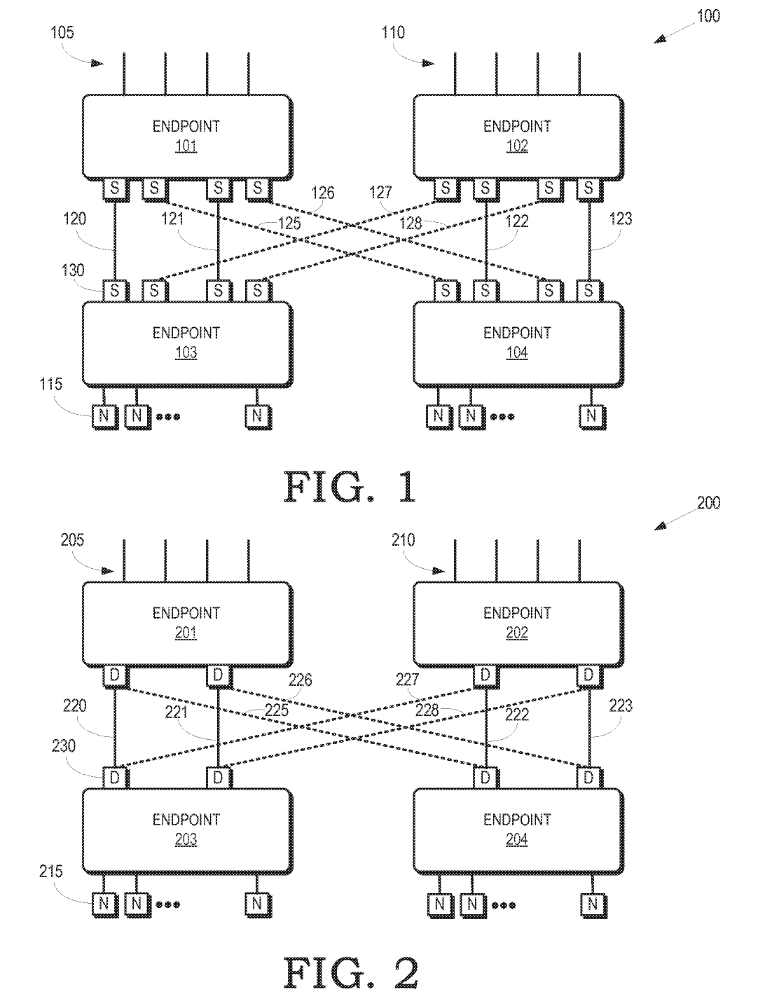

FIG. 1 is a block diagram of an optical network 100 according to some embodiments. The optical network 100 includes endpoints 101, 102, 103, 104, which may be referred to collectively as “the endpoints 101-104.” In some embodiments of the optical network 100, the endpoints 101-104 may be optical network nodes such as electronic routers that are used to route optical signals in the optical network 100. Some embodiments of the optical network 100 may be implemented in a data center and the endpoints 101-104 may be switches. For example, the endpoints 101, 102 may be aggregation switches and the endpoints 103, 104 may be distribution switches. The endpoints 101, 102 can exchange optical signals with other entities (not shown) in the optical network 100 via optical fibers 105, 110, respectively. Some embodiments of the endpoints 101, 102 may be redundant endpoints 101, 102 that receive and transmit the same signals over the corresponding sets of optical fibers 105, 110. The endpoints 103, 104 exchange signals with compute (C) nodes 115 (only one indicated by a reference numeral in the interest of clarity).

The endpoints 101, 102 are interconnected with the endpoints 103, 104 using an optical fiber network that includes primary optical fibers 120, 121, 122, 123 (indicated by solid lines and which may be referred to as “the primary optical fibers 120-123”) and redundant or secondary optical fibers 125, 126, 127, 128 (indicated by dashed lines and which may be referred to as “the redundant optical fibers 125-128”). Each of the primary optical fibers 120-123 and the redundant optical fibers 125-128 are coupled to the corresponding endpoints 101-104 by a single (S) endpoint transceiver 130 (only one indicated by a reference numeral in the interest of clarity). The single endpoint transceivers 130 implement separate receivers and, as discussed herein, the resulting duplication of the reception logic associated with the primary optical fibers 120-123 and the redundant optical fibers 125-128 increases the capital cost of the switch and the power consumed by the endpoints 101-104.

FIG. 2 is a block diagram of an optical network 200 according to some embodiments. The optical network 200 includes endpoints 201, 202, 203, 204, which may be referred to collectively as “the endpoints 201-204.” As discussed herein, the endpoints 201-204 may be optical network nodes such as electronic routers, aggregation switches, or distribution switches. The endpoints 201, 202 can exchange optical signals with other entities (not shown) in the optical network 200 via optical fibers 205, 210, respectively. Some embodiments of the endpoints 201, 202 may be redundant endpoints 201, 202 that receive and transmit the same signals over the corresponding sets of optical fibers 205, 210. The endpoints 203, 204 exchange signals with compute (C) nodes 215 (only one indicated by a reference numeral in the interest of clarity). The endpoints 201, 202 are interconnected with the endpoints 203, 204 using an optical fiber network that includes primary optical fibers 220, 221, 222, 223 (indicated by solid lines and which may be referred to as “the primary optical fibers 220-223”) and redundant or secondary optical fibers 225, 226, 227, 228 (indicated by dashed lines and which may be referred to as “the redundant optical fibers 225-228”).

The embodiment of the optical network 200 depicted in FIG. 2 differs from the embodiment of the optical network 100 depicted in FIG. 1 because each of the primary optical fibers 220-223 and a corresponding one of the redundant optical fibers 225-228 are coupled to a dual (D) endpoint transceiver 230 (only one indicated by a reference numeral in the interest of clarity). The dual endpoint transceivers 230 implement receivers for the primary and redundant optical fibers using consolidated logic that reduces the duplication of resources relative to a pair of single endpoint transceivers such as the single endpoint transceivers 130 shown in FIG. 1. Consequently, the capital cost of the endpoints 201-204 and the power consumed by the endpoints 201-204 may be significantly reduced relative to the corresponding endpoints 101-104 shown in FIG. 1. For example, the dual endpoint transceivers 230 may include optical/electrical (O/E) converters such as photodetectors to couple to the primary optical fibers 220-223 and the redundant optical fibers 225-228. The dual endpoint transceivers 230 may also include an analog switch to receive analog electric signals generated by the O/E converters and selectively provide one of the analog electric signals for conversion to a digital electrical signal. The dual endpoint transceivers 230 are one example of multi-endpoint transceivers that may be implemented in some embodiments, as discussed herein.

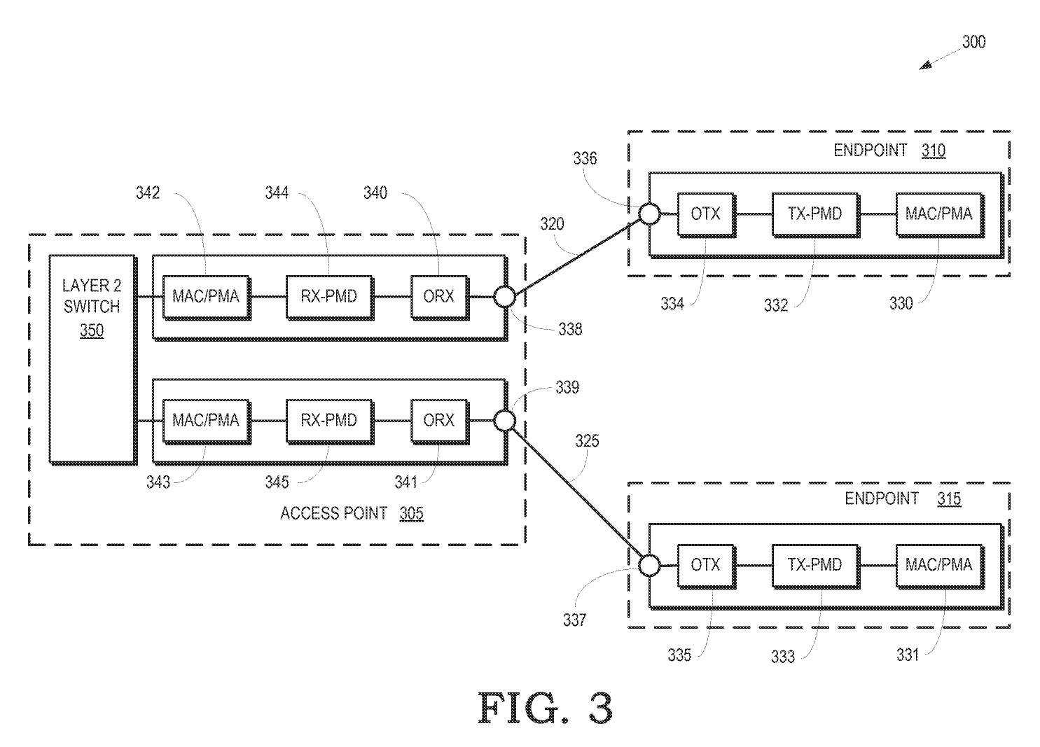

FIG. 3 is a block diagram of an optical network 300 including an access point 305 that is connected to two endpoints 310, 315 by corresponding optical fibers 320, 325 according to some embodiments. Some embodiments of the access point 305 and the endpoints 310, 315 may correspond to portions of the optical network 200 shown in FIG. 2. The endpoints 310, 315 include media access control (MAC) layer physical media attachments (PMAs) 330, 331 that are connected to transmission physical media dependent entities (TX-PMDs) 332, 333. The MAC-PMAs 330, 331 and TX-PMDs 332, 333 configure bits in the transmission bitstream received from a data link layer (or Layer 2) into protocol-specific data frames. Configuring the transmission bit stream includes aligning the frames, adding alignment blocks, scrambling the bits, and encoding the bits. The MAC-PMAs 330, 331 and TX-PMDs 332, 333 may also convert a serial data stream into multiple parallel data streams such as the four lanes used to convey optical data at different wavelengths in a 40GBase LR optical system. The MAC-PMAs 330, 331 and TX-PMDs 332, 333 may also incorporate a clock tone into the bit streams so that symbols in the bit streams can be sampled at an optimal time by a receiver in the access 305. The clock tone may also provide a reference clock for the reception logic. The bit streams are then provided to an optical transmitter 334, 335 that generates the optical signal and provides the optical signal to an optical port 336, 337.

The access point 305 includes optical ports 338, 339 that receive the optical signals from the endpoints 310, 315 and provide the optical signals to optical receivers 340, 341. The access point 305 also includes MAC-PMAs 342, 343 that are connected to reception physical media dependent entities (RX-PMDs) 344, 345. The MAC-PMAs 342, 343 and RX-PMDs 344, 345 implement clock and data recovery logic for extracting a clock tone from the received optical bit streams. The clock tone may be used to sample incoming signals at an optimal time (e.g., in the middle of the symbol), as well as to provide a reference clock signal for digital circuitry in the receive chain. The MAC-PMAs 342, 343 and RX-PMDs 344, 345 may also implement a de-serializer to convert multiple parallel data streams such as the four lanes used to convey optical data at different wavelengths in a 40GBase LR optical system into a single serial data stream. The MAC-PMAs 342, 343 and RX-PMDs 344, 345 may also implement a physical coding sublayer to extract protocol-specific data frames from the received bit streams. The sublayer may perform frame re-alignment, removal of alignment blocks, descrambling of bits, and decoding of bits. Output from the MAC-PMAs 342, 343 and RX-PMDs 344, 345 is provided to a data link layer (e.g., Layer 2).

The access point 305 includes a switch 350 that is implemented in the data link layer. The switch 350 operates on digital signals and may be used to select between the digital bit streams that are generated in response to the optical bit streams provided by the endpoints 310, 315. However, using the switch 350 implemented in the data link layer requires implementing two complete received chains including the duplicated MAC-PMAs 342, 343 and RX-PMDs 344, 345. Multiple layer 2 interfaces such as switch ports, logical addresses, logical buffer space, and the like may also be implemented in the access point 305. Consequently, the access point 305 implements multiple endpoint reception (dual, in this case) in a manner that is substantially equivalent to utilizing multiple (two, in this case) single endpoint receivers. For example, the power consumption of receive chain implemented in the access point 305 is comparable to the power consumption of the two receive chains implemented in two single endpoint receivers.

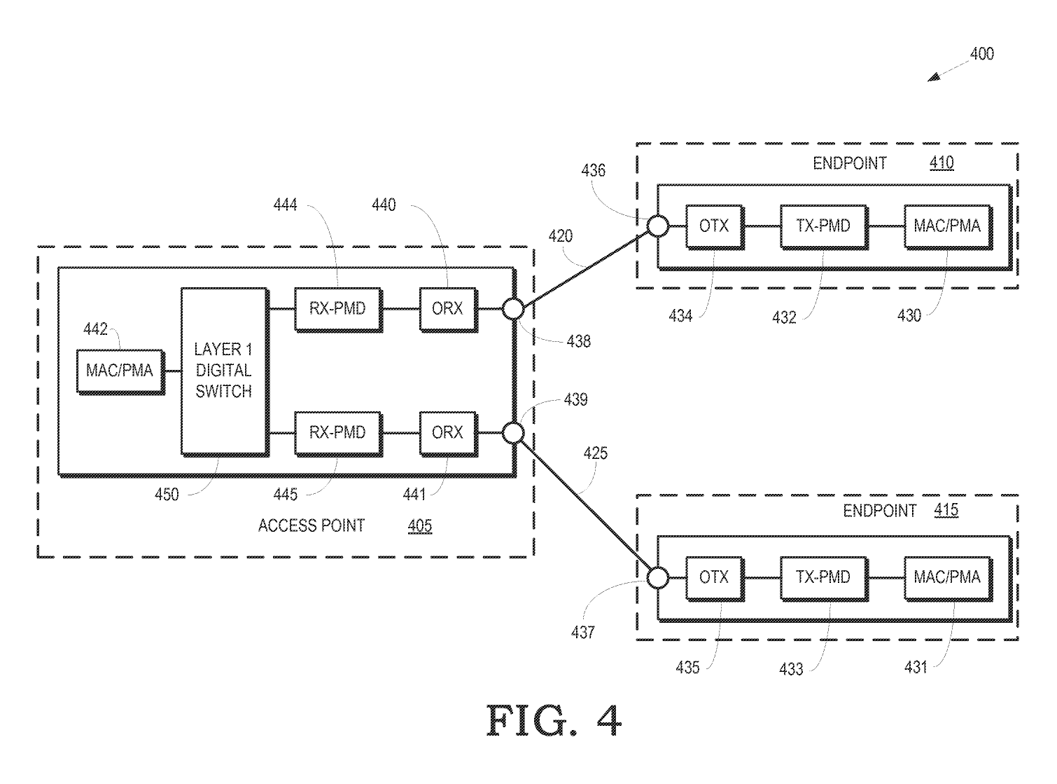

FIG. 4 is a block diagram of an optical network 400 including an access point 405 that is connected to two endpoints 410, 415 by corresponding optical fibers 420, 425 according to some embodiments. Some embodiments of the access point 405 and the endpoints 410, 415 may correspond to portions of the optical network 200 shown in FIG. 2. The endpoints 410, 415 include MAC-PMAs 430, 431 that are connected to TX-PMDs 432, 433. Bit streams from the PMAs 430, 431 and TX-PMDs 432, 433 are provided to optical transmitters 434, 435 that generates the optical signal and provides the optical signal to an optical port 436, 437. The access point 405 includes optical ports 438, 439 that receive the optical signals from the endpoints 410, 415 and provide the optical signals to optical receivers 440, 441. The access point 405 also includes a MAC-PMA 442 and RX-PMDs 444, 445.

The embodiment of the optical network 400 illustrated in FIG. 4 differs from the embodiment of the optical network 300 illustrated in FIG. 3 by implementing a digital physical layer (e.g., Layer 1) switch 450 between the MAC-PMA 442 and the RX-PMDs 444, 445. The switch 450 receives digital bit streams that are generated by the RX-PMDs 444, 445 in response to the optical signals received from the endpoints 410, 415. The switch 450 may then selectively provide one of the digital bit streams to the MAC-PMA 442. Thus, the access point 405 duplicates several components of the receive chain. Consequently, the access point 405 implements multiple endpoint reception in a manner that is substantially equivalent to utilizing multiple single endpoint receivers. For example, the power consumption of receive chain implemented in the access point 405 is comparable to the power consumption of the two receive chains implemented in two single endpoint receivers.

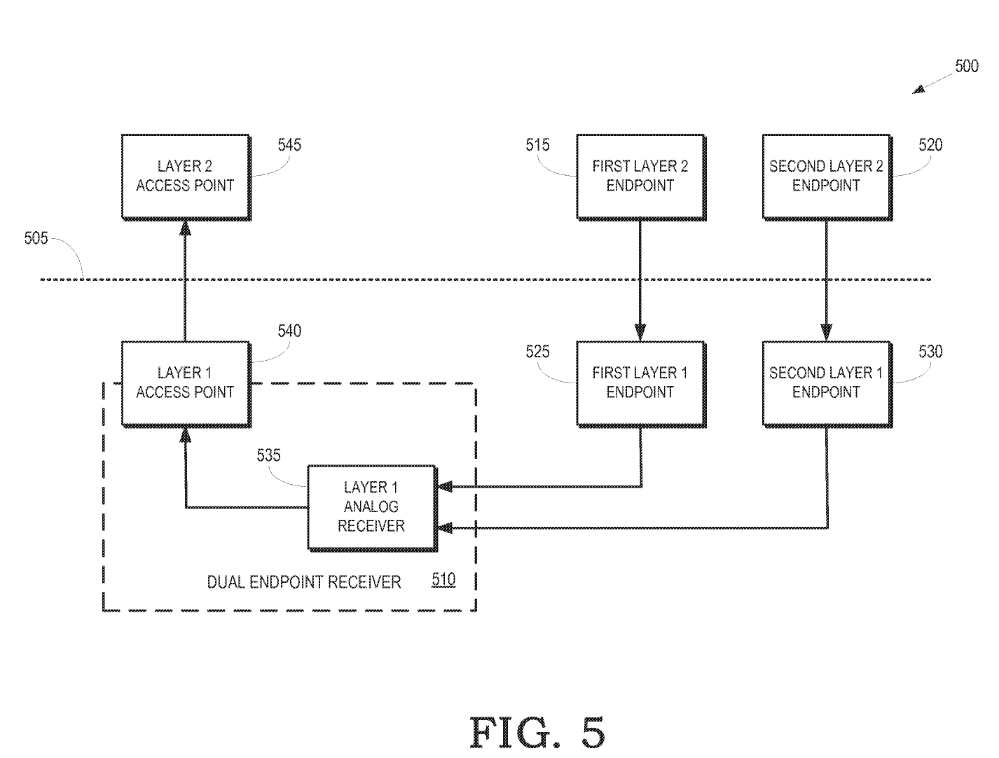

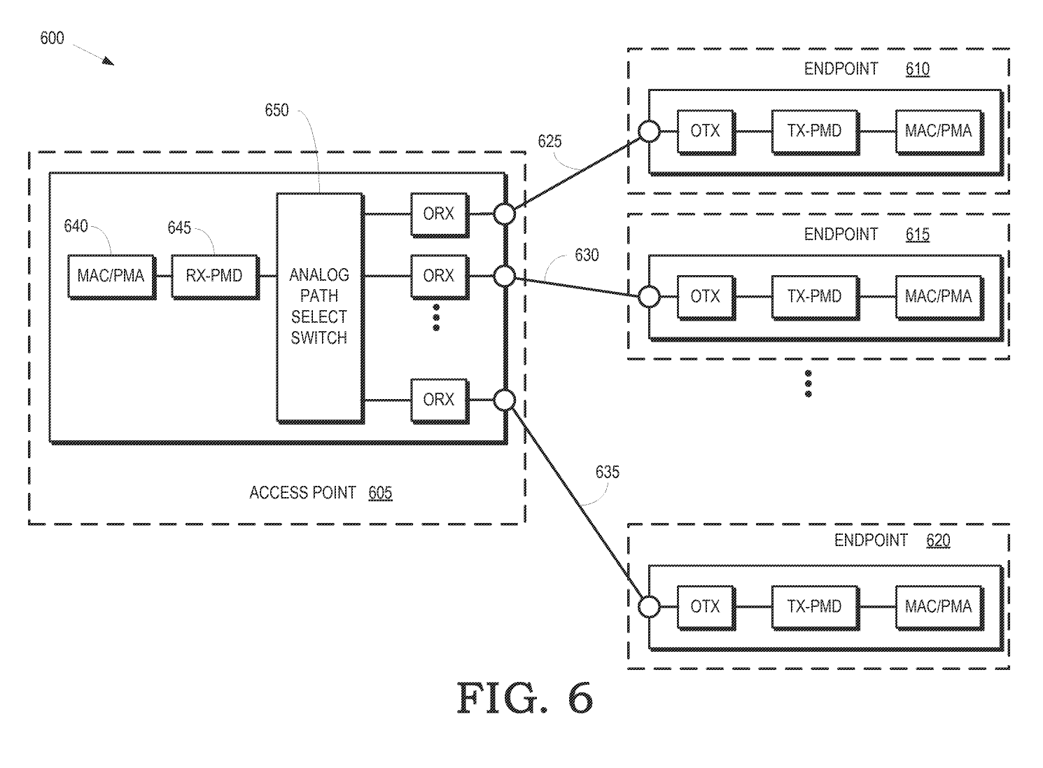

FIG. 5 is a block diagram of a data link layer and a physical layer of an optical network 500 according to some embodiments. Some embodiments of the optical network 500 may correspond to portions of the optical network 200 shown in FIG. 2. Entities implemented in the data link layer (or Layer 2) are positioned above the dotted line 505 and entities implemented in the physical layer (or Layer 1) are positioned below the dotted line 505. Multiple endpoints can provide bit streams to a multiple endpoint receiver. In the illustrated embodiment, first and second endpoints provide concurrent bit streams to a dual endpoint receiver 510. However, some embodiments may include a multiple endpoint receiver that can receive more than two concurrent bit streams from more than two endpoints.

A first bit stream is generated by a first layer 2 endpoint 515 and a second concurrent bitstream is generated by a second layer 2 endpoint 520. The first and second bit streams are provided to first and second layer 1 endpoints 525, 530, respectively. As used herein, the phrase “layer 1 endpoint” and the phrase “layer 2 endpoint” are understood to refer to the layer 1 functionality and the layer 2 functionality, respectively, of the endpoint. Thus, a layer 1 endpoint and a layer 2 endpoint may be implemented in the same physical entity. The same convention may be applied to access points or other entities in the optical network 500 that include both a layer 1 portion and a layer 2 portion.

A layer 1 analog receiver 535 in the dual endpoint receiver 510 receives the concurrent first and second bit streams and selectively provides one of the bit streams to a layer 1 access point 540 that provides the interface between the dual endpoint receiver 510 and a layer 2 access point 545. Some embodiments of the layer 1 analog receiver 535 include optical/electrical (O/E) converters such as photodetectors for receiving the optical bit streams provided by the first and second layer 1 endpoints 525, 530. The layer 1 analog receiver 535 may also include an analog switch to receive analog electric signals generated by the O/E converters and selectively provide one of the analog electric signals to the layer 1 access point 540 for conversion to a digital electrical signal. Embodiments of the optical network 500 may be used to obtain up to a 50% port count reduction in distribution networks (such as the network 200 shown in FIG. 2) that include Layer 1-Layer 2 redundancy, as well as a reduction in the effective switching times of optical cross-connects to under 1 μs.

FIG. 6 is a block diagram of an optical network 600 including an access point 605 that is connected to multiple endpoints 610, 615, 620 by corresponding optical fibers 625, 630, 635 according to some embodiments. Some embodiments of the access point 605 and the endpoints 610, 615, 620 may correspond to portions of the optical network 200 shown in FIG. 2. The endpoints 610, 615, 620 include MAC-PMAs that are connected to TX-PMDs. Bit streams from the MAC-PMAs and TX-PMDs are provided to optical transmitters that generate the optical signal and provide the optical signal to optical port. In the interest of clarity, reference numerals are not used to indicate the MAC-PMAs, TX-PMDs, optical transmitters, or optical ports shown in FIG. 6.

The access point 605 includes optical ports that receive the optical signals from the endpoints 610, 615, 620 and provides the optical signals to optical receivers. In the interest of clarity, reference numerals are not used to indicate the optical ports or the optical receivers in the access point 605. The access point 605 also includes a MAC-PMA 640 and an RX-PMD 645. The embodiment of the access point 605 depicted in FIG. 6 differs from the embodiments of the access points 305, 405 depicted in FIG. 3 and FIG. 4 by implementing an analog path select switch 650 that receives optical signals from the optical receivers and selectively provides an electric analog signal generated in response to one of the optical signals to the MAC-PMA 640 and the RX-PMD 645. Implementing the analog path select switch 650 results in significant capital cost savings due to the reduced number of duplicated components in the receive chain. The analog path select switch 650 also reduces power consumption in the access point 605. For example, as discussed herein, the MAC-PMA 640 and the RX-PMD 645 can consume as much as 90% of the power consumed by the receive chain in the access point 605. Some embodiments of the access point 605 that implement the analog path select switch 650 may therefore have in excess of 30% reductions in the capital cost and power consumption, relative to single endpoint receivers and some embodiments of multiple endpoint receivers such as the embodiments depicted in FIG. 3 and FIG. 4.

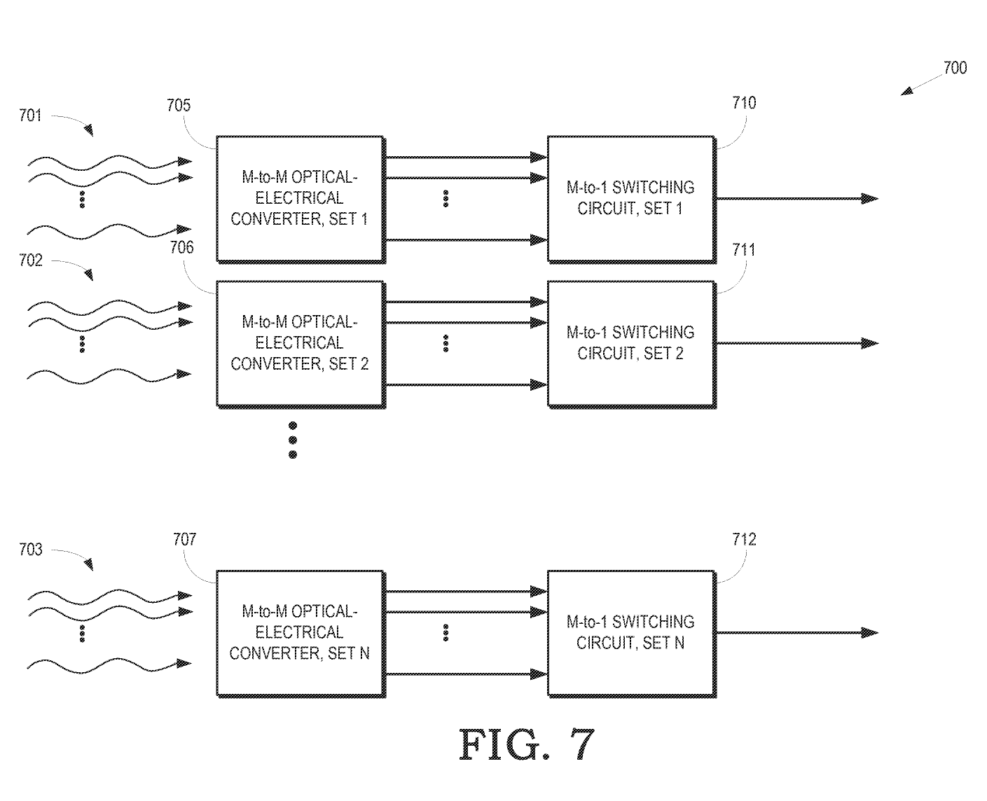

FIG. 7 is a block diagram of an optical network 700 that supports analog multi-endpoint switching for a plurality of optical lanes according to some embodiments. As used herein, the term “lane” refers to optical signals transmitted within a defined portion of the fiber transmission resource, such as any combination of bandwidth(s) around a particular wavelength, polarization(s) in a particular optical mode, mode(s) in a particular optical fiber, fiber(s), or core(s). A single optical network can support multiple lanes at different wavelengths to increase the overall bandwidth or throughput of the optical network. For example, a 100 Gb/s optical network can be created using four lanes that each support 25 Gb/s. The optical network 700 includes independent multi-endpoint switch pathways for N lanes. Each lane in the optical network 700 supports sets of M optical inputs 701, 702, 703, which may be referred to collectively as “the optical input sets 701-703.”

The optical input sets 701-703 are provided to corresponding optical-electrical (O/E) converters 705, 706, 707, which may be referred to collectively as “the O/E converters 705-707.” In the illustrated embodiment, each of the O/E converters 705-707 receives M optical inputs and provides a corresponding set of M analog electrical outputs that are produced in response to the M optical inputs. The M analog electrical outputs associated with the optical input sets 701-703 are then provided to inputs of corresponding analog switching circuits 710, 711, 712, which may be referred to collectively as “the switching circuits 710-712.” The switching circuits 710-712 can selectively provide one of the M analog electric signals to other entities in the optical network 700 (or other networks), e.g., for conversion to a digital electrical signal. Some embodiments of the O/E converters 705-707 or the switching circuits 710-712 may be implemented in the cap layer 1 analog receiver 535 shown in FIG. 5 or the access point 605 shown in FIG. 6.

Some embodiments of the switching circuits 710-712 are configured to provide electrical gain. For example, the switching circuits 710-712 may include one or more amplifiers for amplifying optical or electrical signals in the switching circuits 710-712. Some embodiments of the switching circuits 710-712 are configured to switch states rapidly. For example, the switching circuits 710-712 may be able to switch states to change its output analog electrical signal from one of the input analog electrical signals to a different input electrical signal in less than 1 μs. Some embodiments of the switching circuits 710-712 may also include an electrical interface that generates an output signal in response to the switching circuit changing state.

Some embodiments of the switching circuits 710-712 are configured to automatically switch from a first state (in which a first input analog electric signal is provided to the output of the switching circuits 710-712) to a second state (in which a second input analog electric signal is provided to the output of the switching circuits 710-712) in response to the power of the optical signal corresponding to the first state being below a first threshold, while the power of the optical signal corresponding to the second state is above a second threshold. The first and second thresholds may be equal or the first threshold may be lower than the second threshold to provide a hysteresis. Some embodiments of the switching circuits 710-712 may selectively provide one of the input analog electrical signals based on priorities associated with the input analog electrical signals. For example, the switching circuits 710-712 may selectively provide a first analog input electric signal to the output if the powers of both the first and second optical signals are above the second threshold and the first optical signal is associated with a higher priority than the second optical signal.

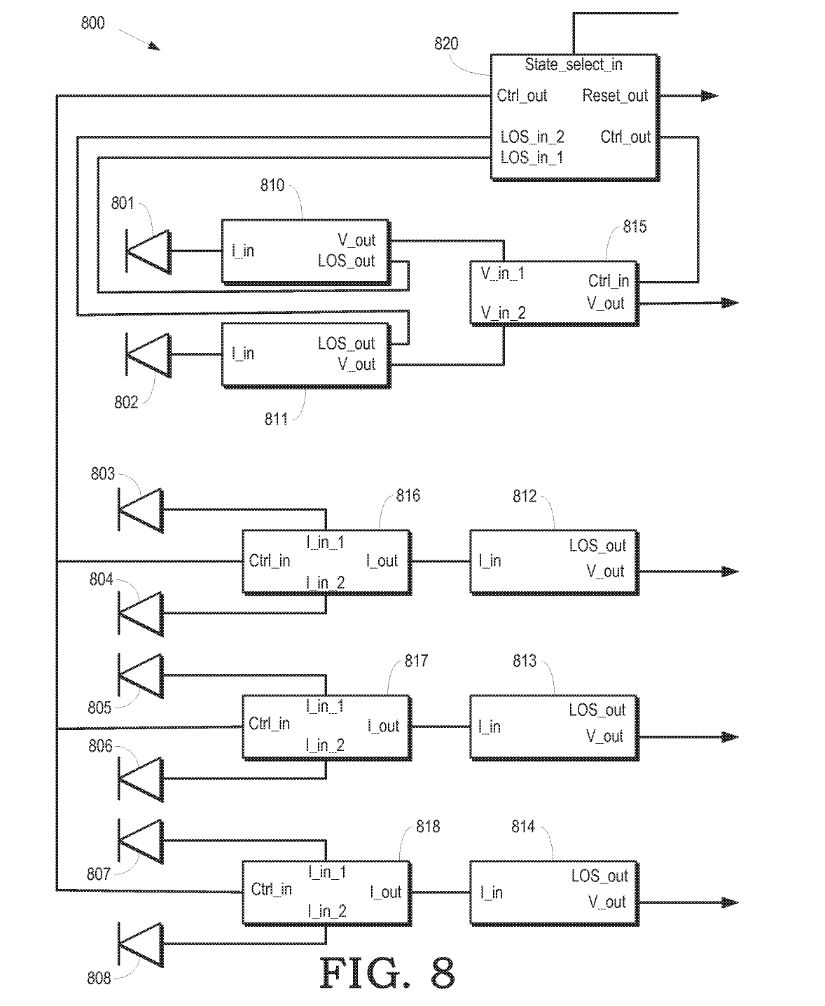

FIG. 8 is a block diagram of a switching circuit 800 according to some embodiments. The switching circuit 800 may be implemented in some embodiments of the dual endpoint receiver 510 shown in FIG. 5, the access point 605 shown in FIG. 6, or the optical network 700 shown in FIG. 7. The switching circuit 800 is configured to receive four sets of optical inputs associated with four corresponding optical lanes. Each set of optical inputs includes two optical inputs, which may be received from corresponding optical fibers. The optical inputs are connected to O/E converters such as photodetectors 801, 802, 803, 804, 805, 806, 807, 808, which may be referred to collectively as “the photodetectors 801-808.” The photodetectors 801, 802 receive the first set of two optical inputs, the photodetectors 803, 804 receive the second set of two optical inputs, the photodetectors 805, 806 receive the third set of two optical inputs, and the photodetectors 807, 808 receive the fourth set of two optical inputs. The photodetectors 801-808 convert the optical signals into analog electrical signals such as a current that is proportional to (or representative of) the intensity of the received optical input.

The switching circuit 800 includes amplifiers 810, 811, 812, 813, 814 (collectively referred to as “the amplifiers 810-814”) that receive an input current (I_in) and provide an amplified output electrical signal such as an amplified output voltage (V_out). The amplifiers 810-814 provide power gain to the analog electrical signal and thus the amplifiers 810-814 provide transimpedance. The amplifiers 810-814 also include an output node (LOS_out) that provides a signal indicating whether the input current is below a threshold that indicates a loss-of-signal (LOS). For example, a signal corresponding to a logical “1” may be asserted at the output node as long as the input current is above the threshold and a logical “0” may be asserted at the output node if the input current falls below the threshold.

The switching circuit 800 also includes switches 815, 816, 817, 818 (collectively referred to as “the switches 815-818”) that selectively provide signals corresponding to one of the input optical signals for each of the four lanes. The switch 815 is a Type 1 switch that receives output voltages provided by the amplifiers 810, 811 at corresponding input nodes (V_in_1, V_in_2) and selectively provides one of the voltages to an output node (V_out) based on a control signal received from a controller 820 at an input control node (Ctrl_in). The switches 816-818 are Type 2 switches and each of the switches 816-818 receives currents provided by a corresponding pair of photodetectors 803-808 at input nodes (I_in_1, I_in_2). The switches 816-818 selectively provide one of the currents to an output node (I_out) based on a control signal received from the controller 820 at an input control node (Ctrl_in).

The controller 820 asserts a control signal at a control output node (Ctrl_out) that is connected to the input control nodes in the switches 815-818. The controller 820 also receives LOS signals from the amplifiers 810, 811 at corresponding input nodes (LOS_in_1, LOS_in_2). The received LOS signals may be used to generate a control signal that configures the state of the switches 815-818 so that the switches 815-818 selectively provide an input signal that has a value above a threshold, as discussed herein. If the values of both the input signals to the amplifiers 810, 811 are above the threshold, the controller 820 may generate control signals to configure the state of the switches 815-818 to provide one of the input signals based on a priority associated with the input signals. The priority may be determined by a state selection signal (State_select_in) that is provided to the controller 820. For example, the controller 820 may implement a logic table such as Table 1 to determine the value of the control signal based on the state selection signal and the LOS signals. The logic implemented by the controller 820 may also be represented as:

Ctrl_out=AND(OR(State_select_in,LOS_in_2),NOT(LOS_in_1))

Some embodiments of the controller 820 include an output node (Reset out) that is used to indicate that the controller 820 has initiated a change of state of the switches 815-818.

TABLE 1

| State_select_in | LOS_in_1 | LOS_in_2 | Ctrl_out |
|---|---|---|---|
| 0 | 0 | 0 | 0 |
| 0 | 0 | 1 | 1 |
| 0 | 1 | 0 | 0 |
| 0 | 1 | 1 | 0 |
| 1 | 0 | 0 | 1 |
| 1 | 0 | 1 | 1 |
| 1 | 1 | 0 | 0 |
| 1 | 1 | 1 | 1 |

In the illustrated embodiment, the controller 820 generate a control signal that indicates that the switches 815-818 are to provide one set of analog electrical signals corresponding to one set of optical inputs based on the LOS_out signals provided by the amplifiers 810, 811. For example, if the amplifier 810 indicates that a value of the optical signal received at the photodetector 801 is above a threshold and the amplifier 811 indicates that a value of the optical signal received at the photodetector 802 is below the threshold, the controller 820 provides a control signal that causes the switches 815-818 to selectively provide output electrical signals corresponding to the optical signals received at the photodetectors 801, 803, 805, 807. Some embodiments of the controller 820 may also receive LOS_out signals from one or more of the amplifiers 812-814 and use the LOS signals to generate control signals for the switches 815-818. The same control signal may be provided to all the switches 815-818 or separate control signals may be provided to subsets of the switches 815-818.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An apparatus, comprising:
a plurality of optical/electrical (O/E) converters to couple to a corresponding plurality of optical fibers;
an analog switch to receive a plurality of analog electric signals generated by the plurality of O/E converters and to selectively provide one of the plurality of analog electric signals for conversion to a digital electrical signal; and
a controller to provide a control signal to the analog switch, wherein the control signal indicates the one of the plurality of analog electric signals, and wherein the analog switch asserts at least one loss-of-signal (LOS) signal to the controller in response to at least one of the plurality of analog electric signals having a value that is below a threshold value.

2. The apparatus of claim 1, further comprising:
at least one physical media dependent entity (PMD) to receive the selected one of the plurality of analog electric signals from the analog switch; and
at least one physical media attachment (PMA) connected to the at least one PMD, wherein the PMA provides a decoded digital electrical signal to a data link layer.

3-4. (canceled)

5. The apparatus of claim 1, wherein the controller provides the control signal having a value determined based on at least one of a plurality of priorities associated with the plurality of O/E converters and the at least one LOS signal.

6. The apparatus of claim 5, wherein the controller receives a state selection signal that indicates the plurality of priorities associated with the plurality of O/E converters.

7. The apparatus of claim 1, wherein the analog switch comprises at least one amplifier to amplify the plurality of analog electric signals generated by the plurality of O/E converters.

8. The apparatus of claim 1, further comprising:
a plurality of switch pathways corresponding to a plurality of optical input lanes of different wavelengths, polarizations, optical spatial modes, optical cores or optical fibers, each of the plurality of switch pathways comprising a plurality of O/E converters to couple to a corresponding plurality of optical fibers and an analog switch to receive a plurality of analog electric signals generated by the plurality of O/E converters and selectively provide one of the plurality of analog electric signals for conversion to a digital electrical signal.

9. A method, comprising:
generating, at a plurality of optical/electrical (O/E) converters, a plurality of analog electric signals in response to a plurality of optical signals received from a corresponding plurality of optical fibers;
selecting, at an analog switch, one of the plurality of analog electric signals for conversion to a digital electrical signal;
receiving, at the analog switch, a control signal that indicates the one of the plurality of analog electric signals; and
asserting, by the analog switch, at least one loss-of-signal (LOS) signal in response to at least one of the plurality of analog electric signals having a value that is below a threshold value.

10. The method of claim 9, wherein selectively providing the one of the plurality of analog electric signals comprises selectively providing the one of the plurality of analog signals to at least one physical media dependent entity (PMD) and at least one physical media attachment (PMA) connected to the at least one PMD, wherein the PMA provides a digital electrical signal to a data link layer.

11-12. (canceled)

13. The method of claim 9, wherein receiving the control signal comprises receiving the control signal having a value determined based on at least one of a plurality of priorities associated with the plurality of O/E converters and the at least one LOS signal.

14. The method of claim 9, further comprising:
amplifying, at the analog switch, the plurality of analog electric signals generated by the plurality of O/E converters.

15. An apparatus, comprising:
a level-2 (L-2) switch, wherein the L-2 switch is configured to be coupled to a plurality of optical fibers by at least one optical receiver, wherein the at least one optical receiver comprises:
a plurality of optical/electrical (O/E) converters to couple to a corresponding plurality of optical fibers;
an analog switch to receive a plurality of analog electric signals generated by the plurality of O/E converters and selectively provide one of the plurality of analog electric signals for conversion to a digital electrical signal; and
a controller to provide a control signal to the analog switch, wherein the control signal indicates the one of the plurality of analog electric signals, wherein the analog switch asserts at least one loss-of-signal (LOS) signal to the controller in response to at least one of the plurality of analog electric signals having a value that is below a threshold value.

16. The apparatus of claim 15, wherein the L-2 switch is at least one of an aggregation switch and a distribution switch.

17. (canceled)

18. The apparatus of claim 15, wherein the controller provides the control signal having a value determined based on at least one of a plurality of priorities associated with the plurality of O/E converters and the at least one LOS signal.

19. The apparatus of claim 18, wherein the controller receives a state selection signal that indicates the plurality of priorities associated with the plurality of O/E converters.

20. The apparatus of claim 15, wherein the analog switch comprises at least one amplifier to amplify the plurality of analog electric signals generated by the plurality of O/E converters.

21. The apparatus of claim 1, wherein the controller is to provide a control signal that indicates a first one of the plurality of analog electric signals that has a value above the threshold value in response to determining that a second one of the plurality of analog electric signals has a value that is below the threshold value.

22. The apparatus of claim 1, wherein the controller is to provide a control signal that indicates a first one of the plurality of analog electric signals that has a value below the threshold value in response to determining that the first one and a second one of the plurality of analog electric signals have the values that are below the threshold value.

23. The method of claim 9, wherein receiving the control signal comprises receiving a control signal that indicates a first one of the plurality of analog electric signals that has a value above the threshold value in response to determining that a second one of the plurality of analog electric signals has a value that is below the threshold value.

24. The method of claim 9, wherein receiving the control signal comprises receiving a control signal that indicates a first one of the plurality of analog electric signals that has a value below the threshold value in response to determining that the first one and a second one of the plurality of analog electric signals have the values that are below the threshold value.

25. The apparatus of claim 15, wherein the controller is to provide a control signal that indicates a first one of the plurality of analog electric signals that has a value above the threshold value in response to determining that a second one of the plurality of analog electric signals has a value that is below the threshold value, and wherein the controller is to provide a control signal that indicates a first one of the plurality of analog electric signals that has a value below the threshold value in response to determining that the first one and a second one of the plurality of analog electric signals have the values that are below the threshold value.
